(19) United States
(12) Patent Application Publication
(10) Pub. No.: US 2008/0230469 A1
(43) Pub. Date: Sep. 25, 2008

(54) DRAIN FILTER ASSEMBLY

(75) Inventors: Aaron J. Cherveny, Minneapolis, MN (US); Michael R. Berrigan, Oakdale, MN (US); Jeffrey R. Janssen, Woodbury, MN (US); Mitchell T. Johnson, Hudson, WI (US); Bobbi L. Pinnow, Woodbury, MN (US); Diane R. Wolk, Woodbury, MN (US); Yifan Zhang, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/689,667

(22) Filed: Mar. 22, 2007

(51) Int. Cl. B01D 35/34; B01D 35/30

(52) U.S. Cl. 210/455; 210/472

(57) ABSTRACT

The disclosure relates to a drain filter assembly that attempts to prevent drain blockages from forming by collecting particles such as food, hair and lint prior to entering the drain. In one embodiment, the filter assembly for filtering fluid passing into a drain comprises a housing and a filter. The housing has an upper portion, a lower portion adjacent the drain, and a perimeter surrounding the drain. The perimeter includes a plurality of openings having a height extending from the lower portion. The filter is adjacent the drain. The filter is contained within the perimeter of the housing.

### FIELD

The present invention relates to a drain filter assembly. In particular, the present invention relates to a drain filter assembly comprising a housing and a removable filter.

### BACKGROUND

Particles such as food, hair, and lint that are washed down a drain can collect and block the passage of fluids down the drain. There are chemical and mechanical mechanisms for removing blockages from drains. However, chemically dislodging a blockage requires handling strong chemicals. Mechanically dislodging a blockage is messy. Preventing the blockage from forming prevents the need to have to later dislodge the blockage.

### SUMMARY

The disclosure relates to a drain filter assembly preventing drain blockages from forming by collecting particles such as food, hair, and lint. In one embodiment, the filter assembly for filtering fluid passing into a drain comprises a housing and a filter. The housing has an upper portion, a lower portion adjacent the drain, and a perimeter surrounding the drain. The perimeter includes a plurality of openings having a height extending from the lower portion. The filter is adjacent the drain. The filter is contained within the perimeter of the housing. In one embodiment, the filter assembly further comprises a base removably secured to the lower portion of the housing. The base includes a support surface for supporting the filter.

In another embodiment, the filter assembly for filtering fluid passing into a drain comprises a housing and a filter. The housing has an upper portion, a lower portion adjacent the drain, and a perimeter with a plurality of openings having a height extending from the lower portion. The filter is enclosed within the housing and is adjacent the perimeter of the housing. The filter has a thickness that is less than the height of the openings.

In another embodiment, the filter assembly for filtering fluid passing into a drain comprises a housing, a base, and a filter. The housing has an upper portion, a lower portion adjacent the drain, and a perimeter with a plurality of openings. The base is removably secured to the lower portion of the housing. The base includes a support surface with an outwardly extending flange and an inner ring surface. The filter is positioned over the support surface of the base and is adjacent the outwardly extending flange and the inner ring surface.

### BRIEF DESCRIPTION OF THE DRAWINGS

FIG. 1 is an exploded view of a first embodiment of a drain filter assembly;

FIG. 2 is a perspective view the assembled drain filter assembly of FIG. 1;

FIG. 3 is a side view of the assembled drain filter assembly of FIG. 1;

FIG. 4 is a perspective view of a second embodiment of an assembled drain filter assembly;

FIG. 5 is an exploded view of a third embodiment of a drain filter assembly;

FIG. 6 is a side view of the assembled base and filter of FIG. 5;

FIG. 7 is a side view of an alternative filter.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

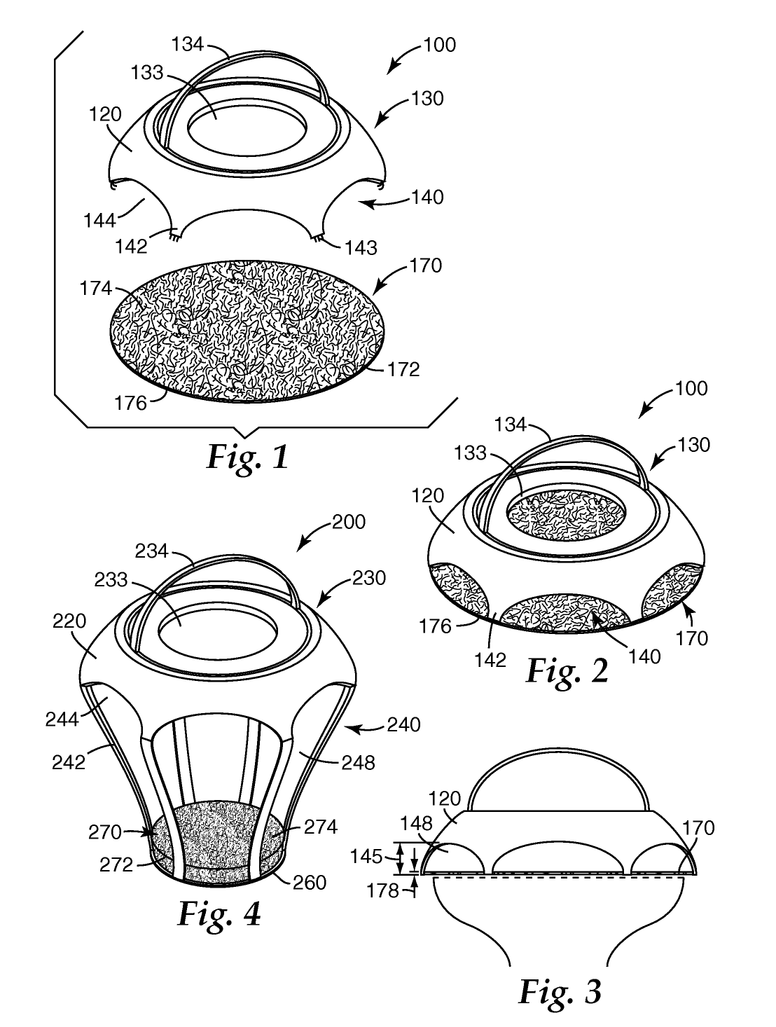

FIG. 1 is an exploded view of a first embodiment of a drain filter assembly 100. FIG. 2 is a perspective view the assembled drain filter assembly 100 of FIG. 1. FIG. 3 is a side view of the assembled drain filter assembly 100 of FIG. 1, shown placed over a drain.

The drain filter assembly 100 includes a housing 120 and a filter 170. The housing 120 includes an upper portion 130 and a lower portion 140. In this embodiment, the upper portion 130 includes an optional opening 133 and handle 134. The lower portion 140 includes a perimeter. In this embodiment, the perimeter of the lower portion 140 rests on a surface that is adjacent the drain (FIG. 3, described in more detail below). Adjacent the perimeter of the lower portion 140 of the housing are a plurality of legs 142 separating openings 144. The opening 144 extend from the perimeter to have a height 145 (FIG. 3).

The housing 120 may comprise a variety of shapes and sizes, although the housing shown is generally circular and therefore has a perimeter, other shapes such as square, oval, triangular are contemplated with the footprint of each of these shapes forming a perimeter. The upper portion 130 shown is generally a dome, however other shapes such as a cone, box, and pyramid are possible. The housing 120 may be constructed from a variety of materials varying in rigidity and durability to achieve a housing 120 that is either reusable or disposable. Suitable materials are a variety of known plastics, metals, paper, or nonwovens. In one embodiment, the material of the housing is not porous.

The filter 170 is positioned within the housing 120. The filter 170 in this embodiment is positioned entirely within the housing 120 extending adjacent the perimeter of the housing 120. The filter 170 includes a catching surface 174. The catching surface 174 is a first surface of contact to catch dirt, debris, particles, hair, and lint. Opposite the catching surface 174 is the resting surface 176. The resting surface 176 is positioned over, near, or adjacent to at least a portion of a drain opening (FIG. 3). The filter 170 may include an additional grabbing mechanism to assist in catching and retaining particles such as dirt, food, hair and lint. A grabbing mechanism may be an adhesive, lofty fiber extensions projecting from the filter, hook-like extensions to capture and entangle particles such as hair and lint.

The filter 170 shown in this embodiment has a substantially uniform thickness throughout. The thickness 178 of the filter 170 at the perimeter 172 of the filter 170 is less than the height 145 of the opening 144 of the housing creating a fluid passage gap 148 (FIG. 3). This allows the fluid from the basin to easily pass though the fluid passage gap 148 to carry the particles across the filter 170 and not simply entangle at the perimeter 172 of the filter 170. The particles are captured within the filter 170 and are prevented from going down the opening into the drain. In addition, the housing 120 helps conceal from view the particles, dirt, food, hair, and lint trapped within the filter.

The optional opening 133 in the upper portion of the housing 120 also allows for fluid carrying particles to pass through. Again, the particles would be captured within the filter 170 and would be prevented from going down the opening into the drain.

The drain filter assembly 100 may include a securing mechanism for securing the drain filter assembly 100 to the basin adjacent the drain. Suitable securing mechanisms include adhesives, mechanical fasteners, suction fasteners. The securing mechanism may be placed on the housing 120 or in this embodiment, may be place on the resting surface 176 of the filter 170.

The filter 170 can be constructed from a variety of material, which allows for liquid to pass through and separate out suspended particles, such as dirt, food, hair, or lint. The filter may be constructed from woven or knitted fabric, nonwoven material, paper, porous film, foam, or sponge. The nonwoven material of polymeric fibers. The fibers may be made from one or more of a variety of thermoplastic polymers that are known to form fibers. Suitable thermoplastic polymers can be selected from polyolefins (such as polyethylenes, polypropylenes, and polybutylenes), polyamides (such as nylon 6, nylon 6/6, and nylon 10), polyesters (such as polyethylene terephthalate), copolymers containing acrylic monomers, and blends and copolymers thereof. Semi-synthetic fibers (such as acetate fibers), natural fibers (such as cotton), regenerated fibers (such as rayon), and other non-thermoplastic fibers can also be blended with the thermoplastic fibers. One example of a nonwoven material is a scrub pad sold under the tradename “Scotchbrite” by 3M Company, St. Paul, Minn. The nonwoven material may be constructed to be relatively stiff or relatively drapable. Also, the nonwoven material may be relatively open and porous, or relatively dense and not as porous. The nonwoven filter 170 can be prepared by any suitable melt forming or mechanical forming operation. For example, the nonwoven may be carded, spunbonded, spunlaced, melt blown, air laid, creped, or made by other processes as are known in the art. The nonwoven can be consolidated by any known technique such as for example hydroentanglement, thermal bonding (e.g. calendar or through air) chemical bonding, needlepunching/needletacking, use of binder fibers, etc. The fibers typically have a denier from about 1 to about 50. The basis weight of the nonwoven may be from about 10 to about 500 grams per square meter in one embodiment, from 50 to about 350 grams per square meter in another embodiment, or less than 100 grams per square meter in another embodiment.

A filter connection mechanism 143 may be included to secure the filter 170 to the housing 120. In this embodiment, the filter connection mechanism 143 includes hook projections with interact and entangle with the lofty nonwoven web of the filter 170 to retain the filter 170 relative to the housing 120. Other filter connection mechanisms 143 are suitable, such as but not limited to, adhesives, mechanical fasteners, support surfaces (such as a base as will be discussed with respect to FIGS. 4-6).

The drain filter housing 120 optionally includes a handle 134 for aiding in picking up the housing 120 and attached filter 170. The handle 134 could be permanently projecting up from the housing 120, as shown if FIG. 1, or may hingedly fall down and be capable of being lifted up. The handle 134 is not required. Other types of mechanisms intended to aid the user in lifting the housing 120 from the basin surface are contemplated such as indentations or projections on the housing 120 surface. For example, a hood-like projection may extend from the openings 144 that a users fingers may be placed under to lift the drain filter assembly 100.

To use the drain filter assembly 100, the filter 170 is connected to the housing 120. In the embodiment shown in FIG. 1, the hooks of the filter connection mechanism 143 interact with and retain the catching surface 174 of the filter 170. Then, the housing 120 is positioned over the opening of the drain with the resting surface 176 of the filter 170 covering the entire opening of the drain (FIG. 3). When a fluid, such as water is exposed to the basin and allowed to drain, the fluid passes through the fluid passage gap 148 and in some instances also the opening 133 of the housing 120 to go down the drain. Any particles such as dirt, food, hair, or lint are captured within the filter 170 and prevented from entering the drain and passing through the drain.

When the filter 170 becomes embedded with particles, the housing 120 and attached filter 170 are removed from the surface of the basin. The filter 170 is discarded. In some embodiments, the entire assembly 100 is intended to be disposable, and the entire drain filter assembly 100 is discarded.

FIG. 4 is a perspective view of a second embodiment of an assembled drain filter assembly 200. The drain filter assembly includes a housing 220, a base 260, and a filter 270. The housing 220 includes an upper portion 230 and a lower portion 240. In this embodiment, the upper portion 230 includes optional opening 233 and handle 234. The lower portion 240 includes a perimeter. In this embodiment, the perimeter of the lower portion 240 rests on a surface that is adjacent the drain (not shown). Adjacent the perimeter of the lower portion 240 of the housing are a plurality of legs 242 separating openings 244. As compared with the embodiment shown in FIG. 1, the legs 242 are longer and relatively flexible. Similar to the description of FIGS. 1-3, the openings 244 extend from the perimeter to have a height that is greater than the thickness of the filter 270 to create a fluid passage gap 248. As discussed above, the housing 220 may comprise a variety of shapes, sizes, and materials. The legs 242 are relatively flexible to allow for insertion into a drain.

The filter 270 is positioned on a filter support surface of the base 260. Although, it cannot be seen in FIG. 4, the filter support surface includes at least one aperture and likely a plurality of apertures to allow fluid to pass through. The filter 270 includes a catching surface 274. The catching surface 274 is a first surface of contact to catch dirt, debris, particles, hair, and lint. Opposite the catching surface 274 is the resting surface (not shown). The resting surface is positioned over the base 260. As discussed above, the filter 270 may include an additional grabbing mechanism.

The filter 270 may be a separate structure from the housing 220 and base 260 or the filter may be integrally formed. For an embodiment, such as that shown if FIG. 4, a filter material may be coated directly onto the base 270 through a process such as an extrusion printing process. Then the filter may be subsequently thermally embossed to create a drain filter assembly 200 where the filter is integral with the assembly. In such an embodiment, the entire filter assembly would be suitable to be disposable.

Because the base 260 is positioned within the canal of the drain, the drain filter assembly is securely retained within the drain. Therefore, a separate securing mechanism is not necessary and is optional.

As discussed above, a filter connection mechanism may be included to secure the filter 270 to the filter support surface 262 of the base 260 to prevent the filter 270 from becoming dislodged and lost within the canal of the drain. As discussed above, the drain filter housing 220 optionally includes a handle 234 or other type of device for aiding in picking up the housing 220 and attached filter 270.

To use the drain filter assembly 200, the filter 270 is placed over the filter support surface 262 of the base 260. Then, the housing 220 is positioned over the opening of the drain while the base 260 and filter 270 are inserted into the opening of the canal of the drain. When a fluid, such as water, is exposed to the basin and allowed to drain, the fluid passes through the fluid passage gap 248 and in some instances also the opening 233 of the housing 220 to go down the drain and pass through the filter 270. The openings in the base 260 allow the fluid to continue down the drain. Any particles such as dirt, food, hair, or lint are captured within the filter 270 and prevented from passing completely through the drain. In addition, the housing 220 help conceal from view the particles, dirt, food, hair, and lint trapped within the filter.

When the filter 270 becomes embedded with particles, the housing 220 is lifted and the base 260 and filter 270 are removed from the canal of the drain. The filter 270 is discarded. In some embodiments, the entire assembly 200 is intended to be disposable and is discarded.

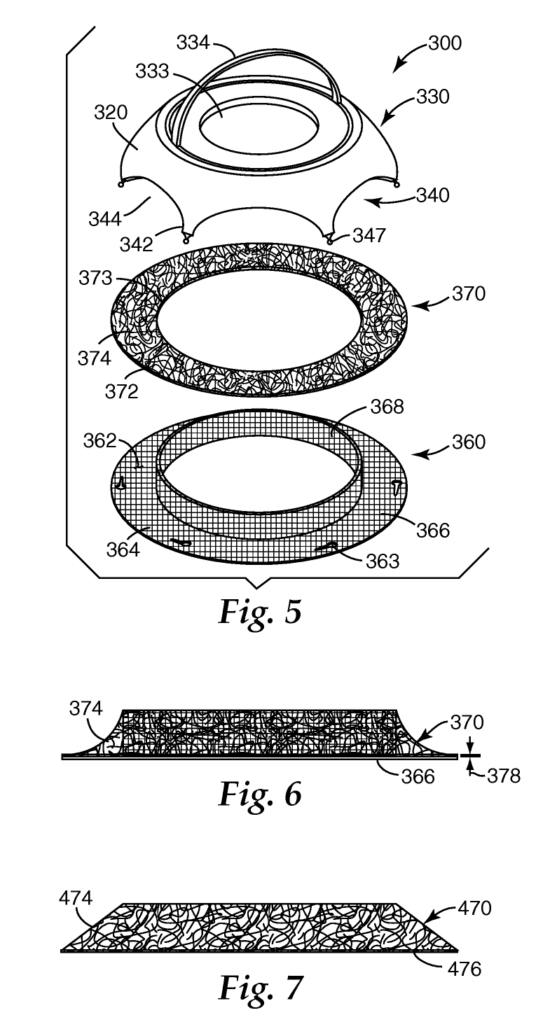

FIG. 5 is an exploded view of a third embodiment of a drain filter assembly 300. The drain filter assembly 300 includes a housing 320, a base 360, and a filter 370. FIG. 6 is a side view of the assembled base 360 and filter 370 of FIG. 5.

The housing 320 includes an upper portion 330 and a lower portion 340. In this embodiment, the upper portion 330 includes an optional opening 333 and handle 334. The lower portion 340 includes a perimeter. In this embodiment, the perimeter of the lower portion 340 rests on a surface that is adjacent the drain (not shown). Adjacent the perimeter of the lower portion 340 of the housing 320 are a plurality of legs 342 separating openings 344. As discussed above for FIGS. 1-3, the openings 344 extend from the perimeter to have a height. As discussed above, the housing 320 may comprise a variety of shapes, sizes, and materials.

The base 360 includes a filter support surface 362. In this embodiment, the filter support surface 362 includes an outwardly extending flange surface 366 and an inner ring surface 368. The filter support surface 362 includes a plurality of apertures 364 for allowing fluid passage. In one embodiment, the filter support surface 362 is a mesh-like material including a plurality of apertures 364.

In this embodiment, protrusions 347 extend from the legs 342 and interact with lock openings 363 to lock the housing 320 to the base 360. Other locking mechanisms are suitable such as, but not limited to, adhesive, mechanical fasteners, suction, and hook projections.

The filter 370 in this embodiment is a ring-like shape with a perimeter 372 and an inner ring 373. The filter 370 includes a catching surface 374. The catching surface 374 is a first surface of contact to catch dirt, debris, particles, hair, and lint. Opposite the catching surface 374 is the resting surface. The resting surface is positioned over the filter support surface 362 of the base 360. The filter 370 conforms over both the outwardly extending flange 366 and the inner ring surface 368, as shown in FIG. 6. As discussed above with respect to FIG. 4, the filter 370 may be integrally formed with the base 360.

The openings 333, 344 in the housing allow fluid to enter the drain. However, because the filter 370 is positioned adjacent the opening of the drain, the fluid passes through the filter 370 prior to entering the drain. The embodiment shown in FIG. 5-6 is particularly suitable for drains that have an actuating stopper where the liquid flows around the perimeter of the stopper. Particles such as dirt, food, hair, and lint are retained within the filter 370 and prevented from going down the opening into the drain. As discussed above, the filter 370 may include an additional grabbing mechanism.

The filter 370 shown in this embodiment has a substantially uniform thickness throughout. The thickness 378 of the filter 370 at the perimeter 372 of the filter 370 is less than the height of the opening 344 of the housing creating a fluid passage gap (as discussed with respect to FIGS. 1-3). This allows the fluid from the basin to easily pass though the fluid passage gap to carry the particles across the filter 370 and not simply entangle at the perimeter 372 of the filter 370. The particles are captured within the filter 370 and are prevented from going down the opening into the drain. In addition, the housing 320 helps conceal from view the particles, dirt, food, hair, and lint trapped within the filter.

The optional opening 333 in the upper portion of the housing 320 also allows for fluid carrying particles to pass through. In an embodiment where the drain opening includes an moveable stopper in the center, the fluid is still carried around the filter 370 at the inner ring surface 368. In such an instance, the inner ring surface 368 ideally lies adjacent the stopper perimeter so that fluid cannot do down the drain without passing through the filter 370.

For, embodiments without a center stopper, a separate cover may be included that could be placed over opening 333 so that fluid only can enter through openings 344 and then must pass filter 370 before going down the drain. Instead of a cover, embodiment without a center stopper may include a housing 120 with a solid cover and not opening 333 at all.

As discussed above, the drain filter assembly 300 may include a securing mechanism for securing the drain filter assembly 300 to the basin adjacent the drain. Suitable securing mechanisms include adhesives, mechanical fasteners, suction fasteners. In this embodiment, the securing mechanism may be placed on the outwardly extending flange 366 of the base 360. As discussed above, a filter connection mechanism may be included to secure the filter 370 to the housing 320. The drain filter housing 320 optionally includes a handle 334 for aiding in picking up the housing 320 and attached filter 370.

To use the drain filter assembly 300, the filter 370 is placed over the base 360 and the housing 320 is connected to the base 360. Then, the housing 320 is positioned over the opening of the drain with the outwardly extending flange 366 of the base 360 adjacent the perimeter of the opening of the drain. When a fluid, such as water, is exposed to the basin and allowed to drain, the fluid passes through the fluid passage gap and in some instances also the opening 333 of the housing 320 to go down the drain. Any particles such as dirt, food, hair, or lint are captured within the filter 370 and prevented from entering the drain and passing through the drain. When the filter 370 becomes embedded with particles, the housing 320 is removed from the surface of the basin. The filter 370 is discarded. In some embodiments, the entire assembly 300 is intended to be disposable, and the entire drain filter assembly 300 is discarded.

FIG. 7 is a side view of an alternative filter 470. The filter 470 shown in this embodiment could be for use with an embodiment of the drain filter assembly 100 shown in FIGS. 1-3, or for use with an embodiment of the drain filter assembly 300 shown in FIG. 5-6. In short, the filter 470 could be solid or have an inner ring. The filter 470 includes a catching surface 474 that is inclined. The catching surface 474 still includes a thickness at the perimeter that would be less than the height of an opening in the housing so that fluid can pass through a fluid passage gap carrying the particles, food, hair and lint across the catching surface 474 of the filter. The resting surface 476 can either rest directly on the surface of the basin (FIG. 3) or could rest on a filter support surface of a base (FIG. 4-5).

Although specific embodiment have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A filter assembly for filtering fluid passing into a drain comprising:
a housing having an upper portion, a lower portion adjacent the drain, and a perimeter surrounding the drain, the perimeter includes a plurality of openings having a height extending from the lower portion;
a filter adjacent the drain;
wherein the filter is contained within the perimeter of the housing.

2. The filter assembly of claim 1, wherein the filter is adjacent the perimeter of the housing.

3. The filter assembly of claim 1, wherein the filter includes a thickness that is less than the height of the openings.

4. The filter assembly of claim 1, wherein the filter entirely covers the drain.

5. The filter assembly of claim 1, wherein the housing is removably secured to the filter.

6. The filter assembly of claim 1, further comprising:
a base removably secured to the lower portion of the housing, wherein the base includes a support surface for supporting the filter.

7. The filter assembly of claim 6, wherein the support surface of the base includes at least one aperture.

8. The filter assembly of claim 6, wherein the support surface includes a securing mechanism for securing the filter to the support surface.

9. The filter assembly of claim 8, wherein the securing mechanism includes hook projections, stem projections, adhesive.

10. The filter assembly of claim 6, wherein the base is secured to the lower portion of the housing with flexible connectors.

11. The filter assembly of claim 6, wherein the support surface of the base includes an outwardly extending flange and an inner ring surface.

12. The filter assembly of claim 11, wherein the filter is supported by both the outwardly extending flange and the inner ring surface.

13. The filter assembly of claim 1, wherein the filter is a woven fabric, knitted fabric, nonwoven web, paper, porous film, foam, sponge or combinations thereof.

14. The filter assembly of claim 1, wherein the filter further comprises a grabbing mechanism for grabbing debris.

15. The filter assembly of claim 14, wherein the grabbing mechanism includes an adhesive, hook projections, loop projection, stem projections, projecting fibers, or combinations thereof.

16. A filter assembly for filtering fluid passing into a drain comprising:
a housing having an upper portion, a lower portion adjacent the drain, and a perimeter with a plurality of openings having a height extending from the lower portion;
a filter enclosed within the housing and adjacent the perimeter of the housing, wherein the filter has a thickness that is less than the height of the openings.

17. A filter assembly for filtering fluid passing into a drain comprising:
a housing having an upper portion, a lower portion adjacent the drain, and a perimeter with a plurality of openings;
a base removably secured to the lower portion of the housing, wherein the base includes a support surface with an outwardly extending flange and an inner ring surface;
a filter positioned over the support surface of the base, adjacent the outwardly extending flange and the inner ring surface.

18. The filter assembly of claim 17, wherein the filter is generally ring shaped with an inner portion and an outer portion.

19. The filter assembly of claim 18, wherein the filter has a substantially uniform thickness.

20. The filter assembly of claim 18, wherein the filter has a thickness adjacent the inner portion of the ring that is greater than a thickness adjacent the outer portion of the ring.
